(19) United States
(12) Patent Application Publication
(10) Pub. No.: US 2020/0267974 A1
(43) Pub. Date: Aug. 27, 2020

(54) NOVEL ATTRACTION OF IMMATURE KHAPRA BEETLE TO CONSPECIFIC AGGREGATION PHEROMONE

(71) Applicants: Trece, Inc., Adair, OK (US); The United States of America, as represented by the Secretary of Agriculture, Washington, DC (US)

(72) Inventors: William R. Morrison, III, Manhattan, KS (US); Bill Lingren, Adair, OK (US)

(21) Appl. No.: 16/800,821

(22) Filed: Feb. 25, 2020

Related U.S. Application Data
(60) Provisional application No. 62/810,366, filed on Feb. 25, 2019.
(60) Provisional application No. 62/839,141, filed on Apr. 26, 2019.

(51) Int. Cl. A01N 31/02; A01N 63/14; A01M 1/02

(52) U.S. Cl. CPC A01N 31/02; A01M 1/02; A01N 63/14

(57) ABSTRACT

Lures containing only the adult-produced pheromones from T. granarium are provided. These lures, and methods for using them, can be employed to trap T. granarium larvae.

### CROSS-REFERENCE TO RELATED APPLICATIONS

This application claims the benefit of U.S. provisional application No. 62/810,366 filed Feb. 25, 2019, and also claims benefit of U.S. provisional application No. 62/839,141 filed Apr. 26, 2019, the disclosures of both are incorporated herein by reference.

This invention was made with government support awarded by the USDA pursuant to the USDA APHIS Farm Bill Section 10007 (goal 6) and the USDA APHIS Agriculture Quarantine and Inspection User Fee program. The government has certain rights in the invention.

### BACKGROUND

The invasive khapra beetle, Trogoderma granarium, is an economically destructive species and the only stored product insect pest that is quarantined in the US. In the past several decades, there have been an increasing number of interceptions of T. granarium at ports in the US. The established trap and lure used for surveillance of T. granarium in high risk areas was developed 30 years ago, but since then new lures have become commercially available. In the US researchers must work with it in an approved quarantine facility, which slows research and development into mitigation strategies for the species. However, there are closely related dermestids already in the US but not under quarantine, such as Trogoderma variabile, which may be able to act as a surrogate species for the behavioral responses of T. granarium. Thus, we evaluated the attraction to, arrestment by, and preference between commercially available lures for immature life stages of both these species and whether T. variabile could serve as a surrogate species for T. granarium. While all lures showed some positive response in each of the assays, the Insects Limited-produced PantryPatrol Gel exhibited the most consistent positive response by T. granarium. This lure contained both a pheromone and kairomone, which may be important for a positive response by larvae to lures. However, the behavioral response of T. variabile was not consistently correlated with that of T. granarium.

Most stored product insect pests are globally distributed as a result of the storing and the trading of agricultural goods around the planet since the dawn of agriculture over 10,000 years ago (Hagstrum and Phillips 2017). However, there remains one significant quarantine stored product pest of concern for most developed countries, namely the invasive khapra beetle, Trogoderma granarium Everts (Coleoptera: Dermestidae). Of the stored product dermestids, T. granarium is one of the most damaging, with a polyphagous host range, though it has a preference for dried vegetable material over animal material (USDA 1986). Specific host commodities of T. granarium include dried seeds, grains, fruits, spices, and gums (Hinton 1945). Trogoderma granarium is most commonly found in Northern Africa, Southern Europe, the Middle East, and India (Burges 1959; Banks 1977; Paini and Yemshanov 2012). In 1953, T. granarium was found in the state of California (Armitage 1 956a), and was subsequently found in surveys at 151 sites in California, Arizona, and New Mexico (Lindgren et al. 1955). The US spent $11 million to eradicate T. granarium, and was ultimately successful (Armitage 1956b). Trogoderma granarium is considered a high risk for introduction, establishment, and damage by the USDA Animal and Plant Inspection Service (APHIS) (Pasek 1998), is listed as an A2 quarantine pest by the European and Mediterranean Plant Protection Organization (EPPO 2017), and has been included among the 100 worst invasive species worldwide (Lowe et al. 2000). Strict quarantine regulations exist in many countries to prevent the introduction of T. granarium, including the US, Canada, and Australia (Eliopoulos 2013). However, there has been an increasing frequency of interceptions at US ports of entry (Myers and Hagstrum 2012), making this a pest of utmost concern to food facilities. Because T. granarium is considered a quarantine pest by APHIS, domestic researchers in the US can only work with the species in an approved containment facility, making research progress cumbersome. The only containment facility in the US to house the species is the USDA-APHIS Plant Protection and Quarantine (PPQ) Center for Plant Health, Science and Technology (CPU ST), in Buzzards Bay, Mass.

There are a variety of closely related dermestids (Castalanelli et al. 2012) that are already commonly found in the US, including the warehouse beetle, Trogoderma variabile Ballion (Coleoptera: Dermestidae) (e.g. Campbell and Mullen 2004). Similar to T. granarium, T. variabile is a persistent pest capable of causing extensive damage (Hagstrum and Subramanyam 2006). Both species have similar life histories that involve feeding on packaged goods containing plant or animal material, and they are associated with grain storage and handling structures (USDA 1986). While T. variabile can persist on many products, the preferred hosts are barley, wheat, mixed animal feeds and processed grains, and an assortment of grocery products (Partida and Strong 1 975). Adults of both T. variabile and T. granarium live only 1-2 weeks (Partida and Strong 1975; Riaz et al. 2014). Recent research has shown that both species respond similarly to exposure on a concrete surface treated with β-cyfluthrin or deltamethrin (Ghimire et al. 2016, 2017; Arthur et al. 2018). This suggests that T. variabile may be used as a substitute species to evaluate how T. granarium may be affected by various insecticides, which is useful because T. variabile is a non-quarantined pest in the US. It would greatly increase the speed of research on the behavior of T. granarium if T. variabile could also be used as a surrogate species in those studies as well, but there are no published data comparing the behavioral responses of the two species.

In countries where T. granarium is a quarantine pest, it is a priority to use the most effective monitoring tools available to detect its arrival at international airports or seaports of entry, as there is an ongoing threat of invasion from locations where T. granarium is endemic (Paini and Yemshanov 2012). Currently, the standard monitoring tool for T. granarium in the US is a wall-mounted trap (Barak 1989), now produced by Trécé Inc. (Adair, Okla.), which is paired with a lure septum containing the T. granarium sex pheromone to attract males and a blend of grain oils as a kairomone to attract larvae (Stibick 2007). These traps are used at sites deemed high risk for invasion by T. granarium in the US. Prior work has established that the 2-component sex pheromone of T. granarium is a mixture of (Z)-14-methyl-8-hexadecenal and (E)-14-methyl-8-hexadecenal in a 92:8 ratio (Cross et al. 1976). The same study also found T. variabile shares the major component of its pheromone with T. granarium, namely the Z isomer (Cross et al. 1976). These two isomers are found in the Trécé-produced lure, which was able to capture nine species of Trogoderma to the sum of over 3,000 individuals from mid-May to November in various trap types (Olson et al. 2013). (Paini and Yemshanov 2012).

Beyond simple trap captures, the behavioral response to semiochemicals by insects consists of a multi-step process (Matthews and Matthews 2010). Usually habitat signals are the first cues perceived, and insects may be conditioned to perceive certain habitats as more favorable than others (Corbet 1985). This is followed by long-distance attraction by volatile compounds, which often times switches to visual, tactile, and other modalities as the insect approaches food, mates, or other resources of interest. While attraction may be part of this orientation process, semiochemicals may also arrest the movement of insects by their intrinsic properties or if they reach a certain threshold (e.g. Morrison et al. 2016). Finally, given competing stimuli, insects may exhibit a marked preference for one stimulus over another. These factors may modulate the effectiveness of a lure in a trap, and therefore, warrant further investigation when evaluating new monitoring tools for invasive species.

The vast majority of studies evaluating the response of T. granarium to commercially available semiochemicals took place several decades ago. However, since then, new traps and lures have become commercially available from a variety of companies. The two main objectives for this study were to 1) evaluate the most effective, commercially available monitoring lures for immature T. granarium, and 2) assess whether the non-quarantined immature T. variabile may be used as a surrogate for T. granarium's behavioral response to semiochemicals. To reach these objectives, three behavioral assays were employed that tested attraction to, arrestment by, and preference for key commercially available lures. This allowed us to identify optimal lures for attracting immature T. granarium, and determine whether the behavioral responses of the two species are correlated in such laboratory assays.

In the past 30 years, no study has evaluated the most effective stimuli for monitoring T. granarium, despite available new products. Given that T. granarium is a quarantined species, this makes research cumbersome.

### SUMMARY OF THE INVENTION

Disclosed herein are methods involving luring T. granarium larvae to a trap using an effective T. granarium larvae luring amount of adult-produced pheromone from T. granarium and optionally a carrier.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1A shows bioassays for attraction, FIG. 1B shows bioassays for arrestment, and

FIG. 1C shows bioassays for preference, for immature T. granarium and T. variabile, according to embodiments of the present invention.

FIG. 2 are graphs of differential attraction to commercial lures by young and old T. granarium larvae in a miniaturized wind tunnel assay, according to embodiments of the present invention.

FIG. 3 are graphs showing mean time spent on each half of a petri dish by young and old T. granarium larvae with different treatments in an arrestment assay, according to embodiments of the present invention.

FIG. 4 are graphs showing mean time spent on each half of a petri dish by young and old T. variabile larvae with different treatments in an arrestment assay, according to embodiments of the present invention.

FIG. 5 are graphs showing the percentage of young and old T. granarium or young and old T. variabile (right) larvae choosing a specific side in a dual choice assay with a variety of attractants, according to embodiments of the present invention.

FIG. 6 are graphs showing the correlation between the behavioral response of T. granarium and T. variabile in attraction, arrestment, and dual choice assays, under constant conditions, according to embodiments of the present invention.

### DETAILED DESCRIPTION

Disclosed herein are methods involving luring T. granarium larvae to a trap using an effective T. granarium larvae luring amount of adult-produced pheromone from T. granarium and optionally a carrier.

Other compounds (e.g., insect control agents known in the art) may be added to the composition provided they do not substantially interfere with the intended activity and efficacy of the composition containing adult-produced pheromone from T. granarium; whether or not a compound interferes with activity and/or efficacy can be determined, for example, by the procedures utilized below.

“Optional” or “optionally” means that the subsequently described event or circumstance may or may not occur, and that the description includes instances in which said event or circumstance occurs and instances where it does not. For example, the phrase “optionally comprising a carrier” means that the composition may or may not contain a carrier and that this description includes compositions that contain and do not contain a carrier. Also, by example, the phrase “optionally adding a carrier” means that the method may or may not involve adding a carrier and that this description includes methods that involve and do not involve adding a carrier.

By the term “effective amount” of a compound or property as provided herein is meant such amount as is capable of performing the function of the compound or property for which an effective amount is expressed. As will be pointed out below, the exact amount required will vary from process to process, depending on recognized variables such as the compounds employed and the processing conditions observed. Thus, it is not possible to specify an exact “effective amount.” However, an appropriate effective amount may be determined by one of ordinary skill in the art using only routine experimentation.

The term “carrier” as used herein includes carrier materials such as those described below. As is known in the art, the vehicle or carrier to be used refers to a substrate such as a mineral oil, paraffin, silicon oil, water, membrane, sachets, disks, rope, vials, tubes, septa, resin, hollow fiber, microcapsule, cigarette filter, gel, fiber, natural and/or synthetic polymers, elastomers or the like. All of these substrates have been used to controlled release effective amount of a composition containing the compounds disclosed herein in general and are well known in the art. Suitable carriers are well-known in the art and are selected in accordance with the ultimate application of interest. Agronomically acceptable substances include aqueous solutions, glycols, alcohols, ketones, esters, hydrocarbons halogenated hydrocarbons, polyvinyl chloride; in addition, solid carriers such as clays, laminates, cellulosic and rubber matrices and synthetic polymer matrices, or the like. The carrier or carrier material as used herein is defined as not including the body of an insect (e.g., Trogoderma species).

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

Study Insects

For all assays, young (0-14 d old) and old (>15 old) T. granarium and T. variabile larvae were used. Trogoderma variabile larvae were derived from a field strain collected from eastern Kansas in March 2016, which has since been continuously reared on pulverized dog food (300 g SmartBlend, Purina One), with rolled oats, and a crumpled, moistened paper towel on the surface in a 800 ml mason jar. T. variabile colonies were held in an environmental chamber at 27.5° C., 60% RH, and 14:10 L:D. T. granarium were kept at 32.0° C., but otherwise similar conditions in the quarantine facility in Buzzards Bay, Mass. All individuals were starved 24-48 h prior to use in experiments.

Attractants

There were five attractants evaluated in this study. These included 0.13 g of PantryPatrol gel (Insects Limited, Inc., Westfield, Ind., US; hereafter, gel), which contains a mixture of the sex pheromoncs for T. variabile, Tribolium castaneum (Herbst) (Coeloptera: Tenebrionidae), Tribolium confusum Jacquelin du Val (Coleoptera: Tenebrionidae), Lasioderma serricorne (F.) (Coleoptera: Anobiidae), and Plodia interpunctella (Hubner) (Lepidoptera: Pyralidae). In addition, the gel has a food-based kairomone for Oryzaephilus surinamensis (L.) (Coleoptera: Silvanidae) and Sitophilus oryzae (L.) (Coleoptera: Curculionidae). Another attractant was 0.13 g of Dermestid tablet attractant (Insects Limited, Inc.; hereafter, tab), which contains multiple food-based kairomones, but no pheromones. The study also included a PHE/WB septa (Trécé, Inc., Adair, Okla., US; hereafter, PHE), which contained the sex pheromones for T. granarium and T. variabiles (Z)-14-methyl-8-hexadecenal and (E)-14-methyl-8-hexadecenal in a 92:8 ratio. Finally, we included 0.13 g of a broad spectrum oil-based kairomone food attractant (Storgard Oil, Trécé, Inc.; hereafter, oil). Attractants were stored below 4° C. until testing was performed. Freshly opened attractants were used within a week of testing, or placed in a freezer before future use. Prior to each use, the attractants were allowed to equilibrate to room temperature. The four attractants above were used as treatments in each of the three laboratory assays below. An additional treatment with 0.13 g of wheat germ (Honeyville, Utah, US) was also included in some experiments as a positive control. In particular, wheat germ (WG, hereafter) was tested as a treatment in the attraction assay below, and was also tested against the control in the dual choice assay and arrestment assay, but not against every other treatment.

Attraction Assay

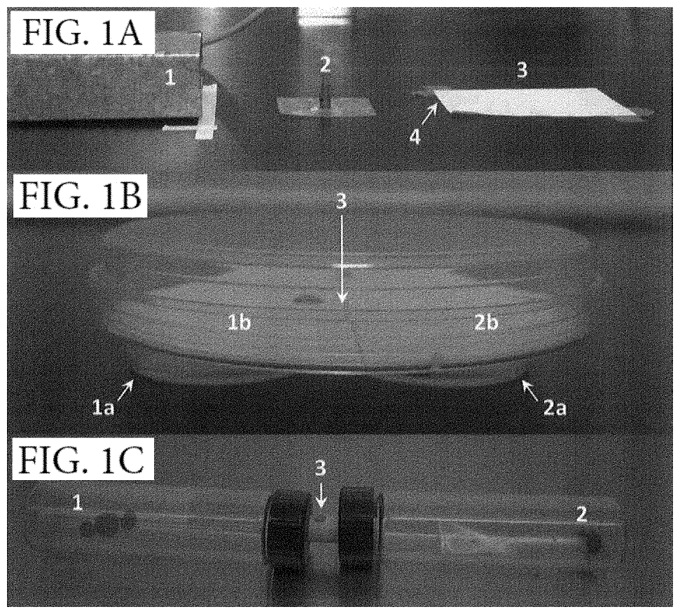

In order to evaluate attraction to the lures above, a miniature wind tunnel assay was employed. The wind tunnel consisted of a 12×12×3 cm L:H:W electric fan that pushed ambient air through a charcoal filter (FIG. 1A), then straightened air flow through a metal grate, and compressed the flow to 12×5 cm over a 26.5 cm distance within a steel encasement. The wind tunnel produced a laminar flow of air at a speed of 1.18 m/s. An arena measuring approximately 10.5×14 cm was placed 16 cm downwind of the wind tunnel, and odor sources were placed upwind exactly halfway between the leading edge of the arena and the wind tunnel. The arenas consisted of paper and were replaced between each trial. Young or old T. granarium or T. variabile larvae were placed in the center of the arena during each trial and given 5 min to make a decision. A decision was considered to be made when a larva translocated more than half of its body mass over the arena's edge. The edge of the arena nearest to the odor source was classified as the stimulus edge, while the other three boundaries were classified as non-stimulus edges. Both the specific edge and the time to make a decision was noted for each larvae. Individuals that did not respond were excluded from the analysis. The upwind assay area was kept free of extraneous odors. All the attractants above, including the wheat germ, were evaluated using this assay. A minimum of 17 replicate individuals per treatment were performed for each life stage and species. Overall, 665 individuals were tested for this experiment.

The three bioassays illustrated by FIG. 1A, FIG. 1B, and FIG. 1C for A) attraction, B) arrestment, and C) preference were performed among immature T. granarium and T. variabile. In the attraction assay (A), the wind tunnel (1) generates air movement the carries the odor source (2) downwind to the release arena (3), where the observer notes whether the larva exits on the stimulus edge (4) of the arena. In the arrestment assay (B), unique semiochemical treatments are loaded in small petri dishes (1a and 2a) centered over a drilled hole in the larger petri dish, which allows diffusion of volatiles into each respective half (1b and 2b), while a single larva is released in the center of the petri dish on the midline (3). To compare preferences among semiochemical treatments (C), unique semiochemical treatments are placed in each vial (1 and 2), and a larva is released in a hole drilled in a pipe connecting the two.

Arrestment Assay

To examine whether any of the lures elicited arrestment, we implemented a tailored behavioral assay (FIG. 1B). In particular, we used large 9×1.5 cm petri dish arenas that had one 5 mm hole punctured halfway between the midline of the dish and the edge on each side of the arena. One of the attractants described above was placed in a separate, smaller 3×1 cm petri dish and centered around each punctured hole under the arena. A piece of filter paper (9 cm, Whatman #1, GE Healthcare, United Kingdom) was placed in the larger arena above to allow larvae to easily move around. The filter paper was bisected with a line and the line was centered halfway between the two punctured holes. A single young or old larvae was placed into the center of the arena on the midline at the beginning of each trial. Each trial was timed at 3 min, and the total time spent on each side of the arena was recorded. A larva was considered to have crossed into the other side of the arena when a majority of the head capsule (>50%) was located past the midline of the arena on the new side. Between trials, arenas were washed with soap and water in triplicate and allowed to dry before reuse. Pairwise comparisons including an unbaited control and each attractant listed above (except wheat germ) were performed. In addition, the unbaited control was tested against another unbaited control and wheat germ as negative and positive controls, respectively. A minimum of 20 replicate individuals were tested per pairwise combination of lure treatments for each life stage and species. Overall, 1,114 individuals were tested in this experiment.

Dual-Choice Assay

To test the preference by T. variabile and T. granarium for the attractants in this study, we employed a dual-choice assay (FIG. 1C). The assay consisted of two glass vials (8.3×2.5 cm H:D) connected by a 4 cm long piece of PVC pipe (6 mm ID) with a 4 mm hole drilled in the center to release larvae halfway between the vials. Each attractant was placed on a 7.6×6.4 cm L:W of plastic, and inserted at the end of a vial. Each larva had 5 min to respond, otherwise they were marked as non-responsive and excluded from data analysis. Old and young larvae of both species were tested. The caps and connectors in the dual choice assays were washed with methanol, then hexane, between each use. At the end of trials on a given day, all the setups were rinsed with soap and water in triplicate. Pairwise comparisons including an unbaited control and each attractant listed above (except wheat germ) were performed. In addition, the unbaited control was tested against another unbaited control and wheat germ as controls. A minimum of 20 responding replicates were performed for every pairwise comparison of attractants for each life stage and species. In total, 1,094 individuals were tested for this experiment.

Statistical Analysis

The attraction assay was analyzed using a generalized linear model based on a binomial distribution. The response variable was coded as a binary variable (yes or no) depending on whether adults left on the stimulus (upwind) edge of the arena or non-stimulus edge (other three sides), using attractant treatment (unbaited control, tab, WG, PHE, oil, and gel lures) as a fixed explanatory variable. A separate model was conducted for each species and life stage. Overdispersion was evaluated and was never a problem for the model, judged as no more than twice the residual deviance divided by the residual degrees of freedom (Aho 2014). Likelihood ratio tests based on a chi-squared distribution were used to assess the significance of the explanatory variable. Multiple comparisons were performed using chi-squared tests with a Bonferroni correction to the cutoff threshold for significance (α=0.05). R Software was used for this and all subsequent statistical analyses (R Core Team 2017).

In order to assess whether T. granarium and T. variabile larvae spent more time on a given half of a petri dish in the arrestment assay, paired τ-tests were used. Paired τ-tests were used because the time spent on one side was inversely proportional to the time spent on the other side of the petri dish, and thus, the measurements are not actually independent. For this, and all other tests, α=0.05 unless otherwise specified.

To evaluate the preference of the larvae in the dual choice assays, a chi-squared test was used. Because each assay is a functionally independent dataset (e.g. a statistical test was not run more than once on the same dataset), no Bonferroni correction was required.

As a summary statistic for the large number of pairwise comparisons in this arrestment and preference experiments, corresponding arrestment and preference indices were calculated for each odor source. Outcomes from a comparison which favor an attractant, do not favor an attractant, or were statistically not significant in the analyses described above were classified as +1, −1, and 0, respectively. These indices were calculated for the five most commonly used attractants and the control. Because wheat germ was only used in one treatment, a meaningful estimate could not be calculated. These were summed and divided by the total number of comparisons involving a given attractant in the dual choice assay or preference assay for all life stages and species. Finally, this was multiplied by 100 to result in a percentage. The preference/arrestment index can range from 100% (in every possible comparison, the attractant was preferred/exhibited arrestment by the larvae) to-100% (in every possible comparison, the larvae chose the opposite treatments over the attractant).

To determine whether T. variabile can act as a surrogate species for T. granarium, the mean behavioral responses for each species were correlated with each other for each assay using the non-parametric Kendall tau procedure. This procedure was selected because the low sample size in at least one assay contributed to deviations from normality.

Results

Attraction Assay

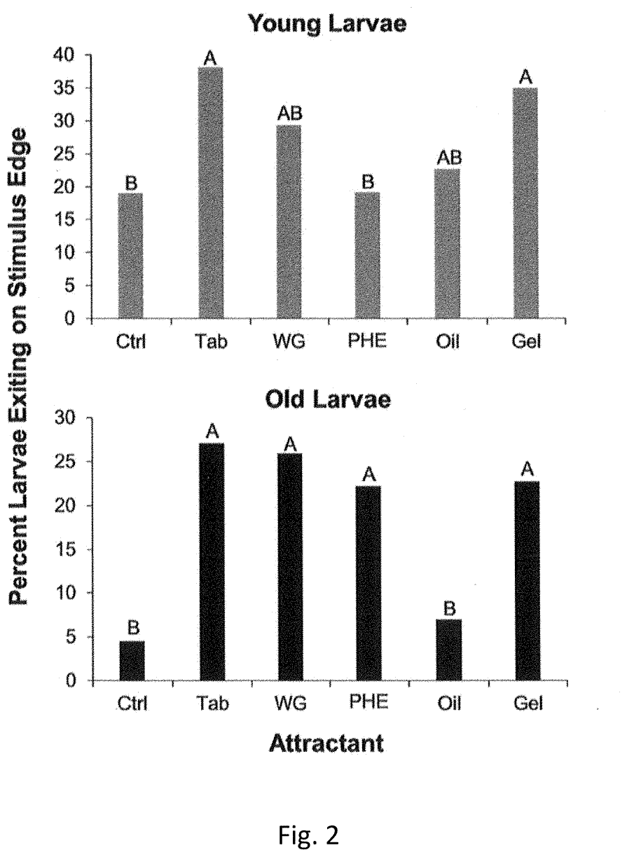

Certain treatments were more attractive to young T. granarium larvae (GLM: χ²=18.2; df=5; P<0.01), with the greatest percentage of larvae orienting upwind towards tab and gel lures, which was about twice as great compared to the percentage for unbaited controls (FIG. 2). Likewise, old T. granarium larvae were more attracted by certain lures (GLM: χ²=15.0; df=5; P<0.01). The tab, WG, PHE, and gel lures were 5-6 times more attractive than the unbaited control and the oil (FIG. 2, pairwise χ²-tests with Bonferroni correction). By contrast, none of the lures were more attractive to young (GLM: χ²=5.40; df=5; P=0.37) or old (τ=1.50; df=23; P=0.15) T. variabile larvae when compared to the unbaited control.

FIG. 2 shows differential attraction to commercial lures by young (17-26 replicates per treatment) and old (27-48 replicates) T. granarium larvae in a miniaturized wind tunnel assay in the Buzzards Bay, Mass. API IIS quarantine facility during 2017-2018 under constant conditions (23° C., 50% RH). Bars with shared letters are not significantly different from each other within a life stage (Pairwise χ²-tests with Bonferroni correction). Results from young (25-32 replicates per treatment) and old (27-36 replicates) T. variabile larvae are not shown because none of the lures were significantly more attractive than the unbaited control. For a full definition of the lures, please refer to the methods.

Arrestment Assay

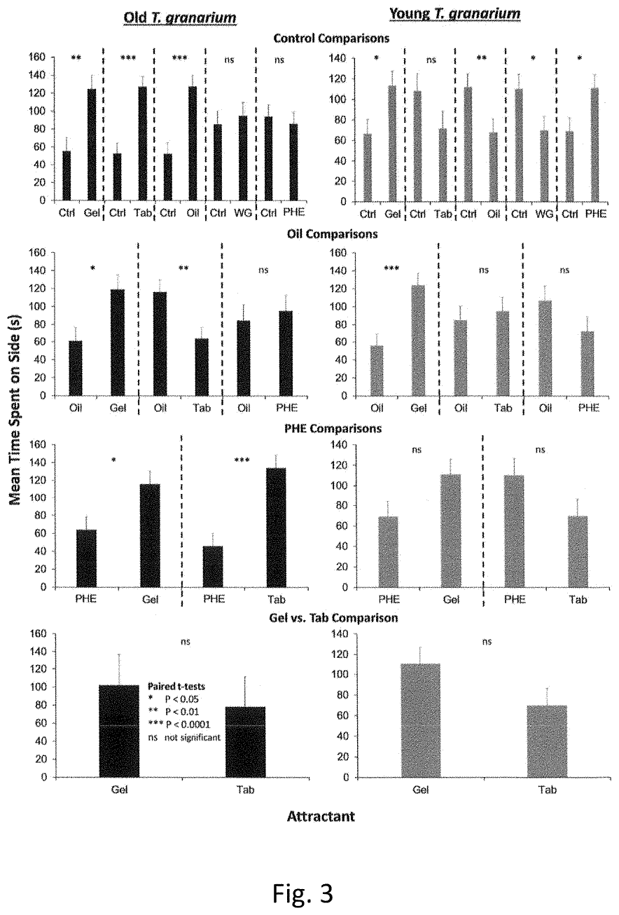

Young T. granarium spent almost twice the amount of time on sides of petri dishes with the gel (paired τ-test: τ=2.40; df=23; P<0.05) and PHE lure (τ=2.28; df=19; P<0.05), compared to controls (FIG. 3). By contrast, young T. granarium spent almost half as much time on sides with the oil (τ=2.40; df=29; P<0.05) and WG lures (τ=2.05; df=19; P<0.05), compared to controls. Young larvae spent over twice more time on sides of petri dishes with gel lures compared to oil (τ=2.64; df=19; P<0.05), though they did not exhibit a preference between sides with oil and tab, or PHE lures (FIG. 3). There were no differences in arrestment between PHE lures and gel (τ=1.42; df=19; P=0.17) or tab lures (τ=1.21; df=19; P=0.24). Finally, there was no significant difference in arrestment between gel and tab lures (τ=1.35; df=19; P=0.19).

FIG. 3 shows mean time spent on each half of a 100 mm (diameter) petri dish by young (right column; 20-30 replicates per pairwise comparison) and old (left column; 20 replicates per pairwise comparison) T. granarium larvae with a different treatment on either side (ctrl, gel, tab, PHE, or WG lure) in an arrestment assay. Individual pairwise comparisons between attractants are separated by a dashed line, and though presented on the same graph, are independent datasets. Abbreviations: ns—not significant, *—P<0.05, **—P<0.01, ***—P<0.0001 (paired τ-tests, α=0.05).

Old T. granarium larvae exhibited a different pattern of arrestments at the attractants compared to young larvae. Old larvae spent 2.2-2.4-fold more time on sides of petri dishes with gel (τ=5.18; df=19; P<0.0001), tab (τ=4.40; df=19; P<0.001), and oil lures (τ=4.39; df=19; P<0.001), compared with controls (FIG. 3). However, arrestment did not significantly differ between controls and either WG or PHE lures. Old granarium larvae spent almost twice as much time on sides of petri dishes with gel lures (τ=2.30; df=19; P<0.05), but almost half as much time with tab lures (τ=4.40; df=19; P<0.01), compared to oil lures. Old larvae spent 2-3-fold more time on sides with gel (τ=2.69; df=23; P<0.05) and tab lures (τ=3.99; df=19; P<0.001) compared with PHE lures. Similar to young larvae, old larvae exhibited no significant difference in arrestment on sides of the petri dish with gel and tab lures (τ=1.50; df=23; P=0.15).

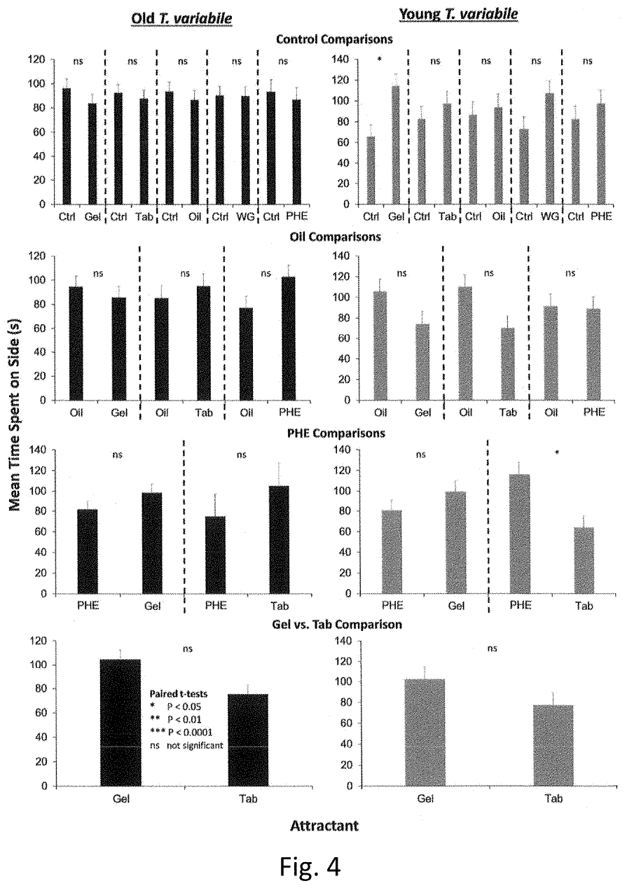

By contrast, T. variabile larvae showed a dissimilar pattern of arrestment to the attractants in this study compared to T. granarium. There were rarely any differences in the time spent on either side of the petri dish when treatments were compared (FIG. 4). The only such significant differences were that young T. variabile larvae spent 2-fold more time on the side with the gel lures (τ=2.14; df=29; P<0.05), and about half as much time on sides with tab lures compared to PHE lures (τ=2.33; df=30; P<0.05).

FIG. 4 shows the mean time spent on each half of a 100 mm (diameter) petri dish by young (right column; 30 replicates per pairwise comparison) and old (left column; 30 replicates per pairwise comparison) T. variabile larvae with a different treatment on either side (ctrl, gel, tab, oil, PHE, or WG lure) in an arrestment assay. Individual pairwise comparisons between attractants (n=30 replicates per comparison) are separated by a dashed line, and though presented on the same graph, are independent datasets.

The overall calculated arrestment index combining both species was the highest for gel, which was 2-3-fold greater than for any other lure, while the control had a negative value (Table 1). The numbers were of greater magnitude when considering T. granarium, alone, with the gel lure 5-, 2.5-, and 1.7-times more arresting than the PHE, tab, and oil lures, respectively (Table 1). Only a couple of the treatment combinations showed significant arrestment behaviors for T. variabile, which is reflected in the very small magnitude for all of the arrestment indices calculated (Table 1).

TABLE 1
Summary indices for arrestment and preference from corresponding
assays for T. granarium and T. variabile.

| | | Arrestment Index¹ | | | Preference Index¹ | | |
|---|---|---|---|---|---|---|---|
| | | | T. | T. | | T. | T. |
| Treatment | Cue Type | Overall | granarium | variabile | Overall | granarium | variabile |
| Control | Unbaited | −20 | −30 | −10 | −42 | −33 | −50 |
| PHE | Pheromone | 12.5 | 12.5 | 12.5 | −44 | −37.5 | −50 |
| Oil | Kairomone | 18.8 | 37.5 | 0 | 25 | −12.5 | 62.5 |
| Tab | Kairomone | 12.5 | 2.5 | 0 | 2.5 | 37.5 | 12.5 |
| Gel | Pheromone + | 37.5 | 62.5 | 12.5 | 38 | 50 | 25 |
| | Kairomone | | | | | | |

Dual-Choice Assay

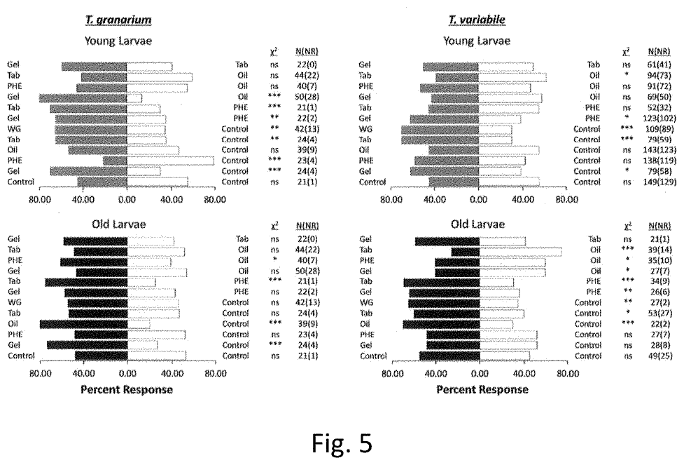

Young T. granarium larvae preferred gel (χ²=16.0; df=19; P<0.0001), tab (χ²=9.0; df=19; P<0.01), and WG lures (χ²=10.2; df=28; P<0.01) by 1.8-2.3-fold over unbaited controls (FIG. 5). Young larvae preferred the unbaited control by 3.7-fold compared to the PHE lure (χ²=33.6; df=18; P<0.0001). There was no significant preference between the unbaited control (χ²=1.0; df=19; P=0.32) or oil lure (χ²=9.0; df=29; P=0.55), compared to unbaited controls. Young T. granarium larvae preferred gel (χ²=51.8; df=21; P<0.0001) by over 6-fold compared to oil lures, but did not exhibit a preference for tab (χ²=3.24; df=21; P=0.07) or PHE lures (χ²=1.0; df=31; P=0.32) compared to oil. Moreover, the young larvae preferred gel (χ²=9.0; df=19; P<0.01) or tab lures (χ²=16.0; df=19; P<0.0001) by 1.9-2.3-fold, respectively, compared to PHE lures. Finally, there was no significant preference by larvae between gel and tab lures (χ²=3.24; df=21; P=0.07).

FIG. 5 shows the percentage of young (20-30 replicates per pairwise comparison) and old (20-35 replicates) T. granarium (left) or young (20 replicates per comparison) and old (20-26 replicates per comparison) T. variabile (right) larvae choosing a specific side in a dual choice assay with a variety of attractants (gel, tab, oil, PHE, WG, and unbaited controls). Trials were run from 2017-2018 at the APHIS quarantine facility in Buzzards Bay, Mass. and at the Center for Grain and Animal Health Research in Manhattan, Kans.

Old T. granarium larvae were generally less responsive to the attractants than the small larvae. Similar to young larvae, old larvae preferred gel lures compared to controls by 2.8-fold (χ²=23.0; df=20; P<0.0001); however, unlike young larvae, old larvae preferred oil lures by a 4-fold difference compared to controls (χ²=33.6; df=18; P<0.0001; FIG. 5). By contrast, old larvae did not exhibit a significant preference for unbaited controls (χ²=0.16; df=20; P=0.69), PHE (χ²=0.16; df=26; P=0.69), tab (χ²=0.36; df=29; P=0.55), or WG lures (χ²=0.64; df=34; P=0.42) compared to controls. Old T. granarium larvae preferred PHE lures (χ²=4.84; df=22; P<0.05) by 1.5-fold compared to oil lures, but not gel (χ²=0.64; df=27; P=0.42) or tab (χ²=0.16; df=28; P=0.69) compared to oil lures. Old larvae preferred tab lures by 3-fold compared to PI IE lures (χ²=25.0; df=20; P<0.0001), but did not exhibit a preference between gel and PHE lures (χ²=1.96; df=20; P=0.16).

Young T. variabile larvae significantly preferred the gel (χ²=5.76; df=20; P<0.05), tab (χ²=16.0; df=19; P<0.0001), and WG lures (χ²=16.0; df=19; P<0.0001) by 1.6-2.3-fold compared to unbaited controls (FIG. 5). By contrast, young larvae did not exhibit a preference between unbaited controls (χ²=1.0; df=19; P=0.32), PHE (χ²=2.56; df=18; P=0.11), or oil (χ²=1.0; df=19; P=0.32) and controls. Young T. variabile larvae exhibit no preference between oil lures and PHE (χ²=0.36; df=18; P=0.55) or gel (χ²=2.56; df=18; P=0.11), but did prefer oil lures compared to tab lures (χ²=5.76; df=20; P=0.05). Larvae chose sides with gel or tab lures exactly equally (χ²=0.01; df=19; P=0.99).

Old T. variabile larvae exhibited different behavioral responses from young T. variabile larvae. Old larvae significantly preferred oil (χ²=16.0; df=19; P<0.0001), tab (χ²=4.0; df=24; P<0.05), and WG lures (χ²=9.0; df=19; P<0.01) by 1.5-2.3-fold compared to unbaited controls (FIG. 5). By contrast, the old larvae did not exhibit a preference between unbaited controls (χ²=1.0; df=19; P=0.32), gel (χ²=0.16; df=24; P=0.69), or PHE lures (χ²=0.16; df=24; P=0.69) compared to controls. Old T. variabile larvae consistently preferred oil lures by 1.5-3-fold compared to gel (χ²=4.0; df=19; P<0.05), PHE (χ²=4.0; df=19; P<0.05), or tab (χ²=25.0; df=19; P<0.0001) lures. In addition, old T. variabile larvae significantly preferred gel (χ²=7.84; df=24; P<0.01) or tab lures (χ²=16.0; df=25; P<0.0001) by 1.8-2.3-fold compared to PHE lures. There was no significant preference between gel and tab lures (χ²=2.86; df=23; P=0.09).

From the dual choice assays, the overall calculated preference index was similarly positive for the oil, tab, and gel lures (25 to 37%), but negative for the pheromone and control (−42 to −44%) (Table 1). However, when the two species were considered separately the gel (50%) and tab (37.5%) were clearly most preferred for T. granarium while the oil (62.5%) was most preferred by T. variabile. Another striking difference between the species was the large number of non-responders for T. variabile, particularly among the younger cohort (FIG. 5).

Correlation of T. granarium and T. variabile Behavioral Response

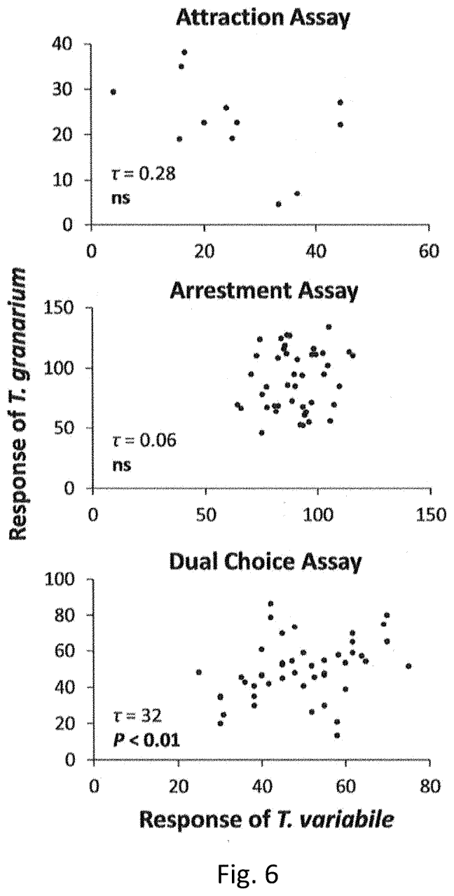

The behavioral responses of T. granarium were not correlated with those of T. variabile (τ=−0.28; df=11; P=0.24; FIG. 6) in the attraction assays. Further, there was no significant correlation between the behavioral responses of both species in the arrestment assay (τ=0.06; df=43; P=0.54). In contrast with the other two assays, surprisingly the behavioral responses of T. granarium and T. variabile in the dual choice assay were significantly correlated with each other (t=0.32; df=47; P<0.01).

FIG. 6 shows the correlation between the behavioral response of T. granarium and T. variabile in three assays (attraction, arrestment, and dual choice) under constant conditions (23° C., 50% RH).

Discussion

Our study is the first on the most effective commercially available attractants for T. granarium in the past thirty years (e.g. Barak 1989), and the first published report to systematically test the ability of these commercial lures to attract and arrest immatures of both T. granarium and T. variabile. The most attractive lure for immature T. granarium as assessed by the wind tunnel experiments was the gel, followed by the tab lure, while the PHE and oil lures were not significantly different from the control. Importantly, both gel and tab lures contain food kairomones, some specifically targeted to dermestids. Historically, food bait traps comprising a blend of dried seeds and fruits have been used for monitoring stored product beetles (Pinniger 1975; Bains et al. 1976). Myristic, palmitic, and stearic acid have been shown to be attractive to T. granarium, while valeric, heptanoic, and picric acids are repellent (Levinson et al. 1978). However, Levinson et al. (1978) found that methyl and ethyl oleate, ethyl linoleate, ethyl palmitate, and ethyl sterate were 6-8-fold less attractive than the aggregation pheromone for T. granarium, and classified them as nonspecific attractants. Other stored product insects, such as Sitophilus oryzae (L.) (Coleoptera: Curculionidae), also respond to a variety of cereal volatiles, though their response may be concentration-dependent (Germinara et al. 2008). Importantly, there are likely other volatile sources, such as feces, which may additionally contribute to the attraction and behavioral response of T. granarium (Stanic and Shulov 1972).

While attraction is one component of the behavioral response by insects to lures, retention or arrestment at the lure is another important consideration. Overall, the most arresting lure tested was the gel and oil lure, but the effect was much more pronounced for T. granarium than T. variabile. In the presence of their aggregation pheromone, adult male T. granarium behavior is characterized by vibration of antennae, intermittent stops, and a zig-zag pattern of movement, while females are temporarily immobilized (Levinson and Ilan 1970). In other systems, both the invasive Halyomorpha halys (Stål) (Hemiptera: Pentatomidae) and the native Murgantia histrionica (Hahn) (Hemiptera: Pentatomidae) exhibit increased arrestment at locations when both food cues (e.g. apple trees or collard plants) and their aggregation pheromone are present (Morrison et al. 2016; Wallingford et al. 2018). The presence of arresting stimuli has the ability to change foraging behavior, including increasing patch searching time and turning rates, while reducing speed, as has been shown for the egg parasitoid, Trissolcus basalis (Wollaston) (Hymenoptera: Scelionidae) (Colazza et al. 2004). It may result in the cessation of movement altogether (Morrison et al. 2016; Morrison et al. 2018a), which raises the question of how effective a stimulus will be when paired with a trapping device or kill mechanism (e.g. Morrison et al. 2018b), especially if reduced or cessation of movement occurs before entering a trap or kill zone. However, arrestment is an understudied feature of the chemical ecology of stored product insects, despite its importance in determining whether monitoring devices are behaviorally compatible with pest biology.

Preference among competing stimuli is an important aspect to consider when optimizing surveillance tools for insects. Our results suggest that the gel lure, followed by the tab lure, were the most preferred lures for immature T. granarium. Alternatively, the oil was most preferred for T. variabile. In every ease, kairomones are important for these species, and it appears that a combination of kairomones and pheromone is important for T. granarium. In some cases, pheromones tend to play a more important role over food kairomones, but the opposite is also possible (reviewed in Reddy and Guerrero 2004). However, in some species, such as the brown marmorated stink bug, Halyomorpha halys (Stål) (Hemiptera: Pentatomidae), both kinds of cues may be important and may enhance each other's effects (Morrison et al. 2016). The mechanism for the differential attraction between these two species and the role that the presence of pheromones, kairomones, or both stimuli together play is worth following-up on in future studies. While this assay provides an indication of preference between the two lures in the absence of external cues, follow-up studies in the field should address whether the volatiles emitted by these two lures are competitive in a grain storage environment with a substantive amount of background food odors, as the context under which volatiles are perceived can modulate the behavioral response of insects (Webster et al. 2010).

We have also assessed whether T. variabile can act as a behavioral surrogate species for T. granarium. Prior work has suggested that T. variabile responds similarly to T. granarium after insecticide exposure (Ghimire et al. 2016), and shares many similar life history traits (Hagstrum and Subramanyam 2006). However, the behavioral responses of T. granarium were not consistently correlated with T. variabile, suggesting that one species cannot substitute for the other when considering their behavioral ecology. However, there are other closely related dermestids that may be alternative candidate surrogate species, including the larger cabinet beetle, Trogoderma inclusum LeConte (Coleoptcra: Dermestidae). For example, prior work has shown that T. granarium and T. inclusum also respond similarly to two pyrethroid insecticides (Ghimire et al. 2017). In addition, T. inclusum and T. granarium both equally respond to the isolated pheromone of T. inclusum, 14-methyl-cis-8-hexadecen-1-ol and methyl-14-methyl-cis-8-hexadecenoate (Rodin et al. 1969). It may be worth investigating whether this species has the ability to act as a surrogate species for the behavioral responses of T. granarium.

Surprisingly we found a preference to the PHE lure (containing only pheromone) by small T. granarium larvae. Up to this point, there have never been any reports of attraction by T. granarium larvae to the adult-produced pheromones from conspecifics. It is possible that larvae, when first hatched, seek out new food sources, and the presence of the pheromone from conspecifics may indicate a food patch of reasonable quality. Some species of invertebrates, such as the larvae of Caenorhabditis elegans, are induced to form a dispersal stage in the presence of pheromone from conspecifics (Golden and Riddle 1984). In true bugs, nymphs are commonly attracted to emissions of aggregation pheromones from adults (Leskey et al. 2015). While our data cannot confirm that T. granarium use the pheromone to assess food patch quality, it may be worth exploring this mechanism in the future.

Overall, we have contributed relevant knowledge about the fundamental behavioral response of immature T. granarium and T. variabile to commercially available lures for their surveillance. Moreover, we have shown that the behavioral response of T. variabile surprisingly cannot be substituted for that of T. granarium. Future research must address 1) the performance of these lures when combined with traps for capturing T. granarium, 2) the optimum trap design, and 3) the field-level response by populations of these and other species in the context of the full array of stored product pests that are found in environments that are routinely monitored, such as grain storage and production facilities. Information from this study and future planned studies will be able to give sufficient information to make recommendations for an optimal monitoring tool to effectively exclude T. granarium from the US.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

All of the references cited herein, including U.S. patents and U.S. patent application Publications, are incorporated by reference in their entirety.

What is claimed is:

1. A method comprising: luring T. granarium larvae to a trap using an effective T. granarium larvae luring amount of adult-produced pheromone from T. granarium and optionally a carrier.
